(19) United States
(12) Patent Application Publication
(10) Pub. No.: US 2026/0036786 A1
(43) Pub. Date: Feb. 5, 2026

(54) LENS, LENS UNIT, OPTICAL DEVICE, IMAGE PICKUP APPARATUS, AND METHOD OF MANUFACTURING LENS

(71) Applicant: CANON KABUSHIKI KAISHA, Tokyo (JP)

(72) Inventors: SHUNICHI MIYAZAWA, Tochigi (JP); SHIGEO URAI, Saitama (JP); SATOSHI INOUE, Tochigi (JP)

(21) Appl. No.: 19/282,315

(22) Filed: Jul. 28, 2025

(30) Foreign Application Priority Data
Jul. 31, 2024 (JP) 2024-125002

(51) Int. Cl. G02B 13/00; H04N 23/51; H04N 23/55

(52) U.S. Cl. CPC G02B 13/0035; H04N 23/51; H04N 23/55

(57) ABSTRACT

Provided is a lens which has an aspherical surface and is capable of capturing an image in a wide range, and which is more stably provided. The lens includes a first part, which is made of a first material, and has a concave surface; and a second part, which is made of a second material, and is to be bonded to the concave surface side of the first part. The second part is formed into a ring shape, and the second part defines a half aperture angle of a ray effective diameter to an angle of 65 degrees or more and 90 degrees or less.

### BACKGROUND

### Field of the Technology

The present disclosure relates to a lens exemplified by a wide-angle lens to be used in an in-vehicle camera or the like, a lens unit including the lens, an optical device, an image pickup apparatus, and a method of manufacturing the lens.

### Description of the Related Art

For a lens used in an in-vehicle camera or the like, a wide-angle lens is often used in order to capture an image in a wide range. There has been known a wide-angle lens that achieves a wide angle through use of a spherical surface. However, such a wide-angle lens causes an increase in the aberration at an image peripheral portion, and a clear image may not be obtained. As a countermeasure against the foregoing, for example, there is a method of correcting the aberration at the peripheral portion with image software. However, there is a time lag in processing of a moving image, and it has been known that a clearer image can be obtained by correcting the aberration with the lens itself. Accordingly, it is considered that use of an aspherical lens to correct the aberration described above is more effective.

Moreover, in order to capture an image in a wide range, use of an aspherical lens having a large half aperture angle on a concave surface side of the wide-angle lens is more effective. For example, Japanese Patent Laid-Open No. H03-013902 discusses a method of producing such an aspherical lens.

As a method of producing an optical element having a structure similar to that of an aspherical lens, there have been known manufacturing methods such as a replica method as discussed in Japanese Patent Laid-Open No. H03-013902 and an injection molding method. In those manufacturing methods, for example, the wide-angle lens may crack at the time of being released from a mold, and there has been a demand for stable provision of a wide-angle lens or a lens having a structure similar to that of such a wide-angle lens.

### SUMMARY

An aspect of the present disclosure is directed to more stably provide a lens which has an aspherical surface and is capable of capturing an image in a wide range.

According to an aspect of the present disclosure, there is provided a lens including: a first part, which is made of a first material, and has a concave surface; and a second part, which is made of a second material, and is configured to be bonded to the concave surface side of the first part. The second part is formed into a ring shape, and the second part defines a half aperture angle of a ray effective diameter to an angle of 65 degrees or more and 90 degrees or less.

Features of the present disclosure will become apparent from the following description of embodiments with reference to the attached drawings. The following description of embodiments is described by way of example.

### BRIEF DESCRIPTION OF THE DRAWINGS

FIG. 1 is a cross-sectional view of a wide-angle lens according to the one embodiment of the present disclosure.

FIG. 2 is a view for illustrating an example of a schematic configuration of an apparatus for manufacturing the wide-angle lens according to the one embodiment of the present disclosure.

FIG. 3 is a view for schematically illustrating an example of a mold release style using a push-up pin in a related-art manufacturing method.

FIG. 4 is a view for schematically illustrating an example of a mold release style using cooling in a related-art manufacturing method.

FIG. 5 is an explanatory schematic view for illustrating an example of a method of manufacturing an optical lens according to the one embodiment of the present disclosure.

FIG. 6 is an explanatory schematic view for illustrating a case in which a parallel light beam has entered the wide-angle lens exemplified in FIG. 1.

FIG. 7A is a view for illustrating a schematic configuration of an optical device to which the wide-angle lens according to the one embodiment of the present disclosure is applied.

FIG. 7B is a view for illustrating a schematic configuration of an example of an image pickup apparatus to which the wide-angle lens according to the one embodiment of the present disclosure is applied.

FIG. 8 is a cross-sectional view of a wide-angle lens according to the one embodiment of the present disclosure.

### DESCRIPTION OF THE EMBODIMENTS

In manufacturing methods known in the related art, for example, a wide-angle lens may crack at the time of being released from a mold. As a countermeasure against the foregoing, the present disclosure stably provides a wide-angle lens or a lens having a structure similar to that of such a wide-angle lens.

An exemplary embodiment for carrying out the present disclosure and Examples are described in detail with reference to the attached drawings. The dimensions, materials, shapes, and relative positions of the components described in the following embodiment and Examples may be freely selected, and the configuration of the device to which the present disclosure is applied may be changed, based on various conditions. The same reference symbols are used to denote components that are the same as one another or functionally similar to one another among the drawings.

The present disclosure relates to a lens. In the following embodiment and Examples, a wide-angle lens is provided as an example of one mode of the lens is described in detail.

### Embodiment

### [Shape of Wide-Angle Lens]

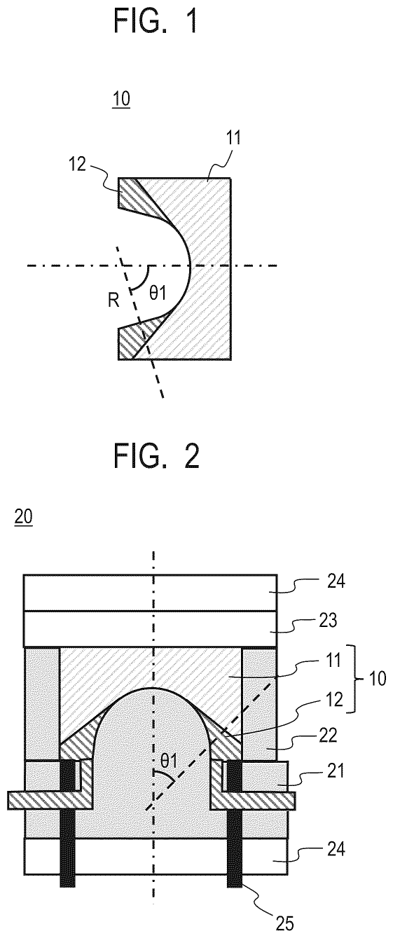

A shape of a wide-angle lens 10 provided as an example of one mode of the present disclosure is described. The wide-angle lens 10 has a concave shape as illustrated in FIG. 1, which is a cross-sectional view taken along an optical axis. The wide-angle lens 10 exemplified in FIG. 1 includes: a first part 11 which is made of a first material and has a concave shape; and a second part 12 which has a ring shape and is made of a second material, the second part 12 being bonded so as to be positioned on a concave surface side of the first part 11 and at a circumference of a ray effective diameter and in the vicinity thereof.

In the wide-angle lens 10 may, for example, have a thickness of a center of a concave portion of the first part 11 that can be 2 mm. A surface of the first part 11 opposite to a concave surface in which the concave portion is formed can be a flat surface. Further, the ray effective diameter of the concave surface of the first part 11 in the exemplified wide-angle lens 10 can be, for example, 28 mm. Moreover, in the exemplified wide-angle lens 10, with the second part 12 being bonded, a half aperture angle θ1 can be increased to be larger than a half aperture angle of the first part 11 alone. In this case, the half aperture angle θ1 is defined by, for example, bisecting a central angle of a sector obtained by connecting a center of an imaginary sphere forming an arc of the concave surface with both end portions of the arc. The illustrated shape, dimensions, and the like of the wide-angle lens 10 are merely examples, and the present disclosure is not limited to the content described here.

### [Material for Wide-Angle Lens]

Next, a material for forming the wide-angle lens 10 is described. As the first material for forming the first part 11, glass which is excellent in mechanical strength and transmittance and has many variations can be used. Through use of a material having a high mechanical strength, the thickness of the center portion of the first part 11 can be reduced to achieve thinning of the wide-angle lens 10.

As the second material for forming the second part 12, resin is suitably used in order to prioritize resistance to cracking at the time of manufacture. In this embodiment, the first material and the second material both have a refractive index (nd) of 1.5. However, the value of the refractive index is not limited to the description given herein, and can be changed as appropriate depending on the application or the like of the wide-angle lens 10.

### [Method of Manufacturing Wide-Angle Lens]

Next, a method of manufacturing the wide-angle lens 10 according to one embodiment of the present disclosure is described. In the manufacturing method described below, it is preferred that polished glass be used in the spherical surface of the first part 11. It is known that spherical glass is inexpensive and has fewer problems at the time of manufacture. Further, through use of the spherical glass, at the time of bonding the second part 12, the second part 12 can be bonded without losing the shape, even at high temperature.

In this case, an injection molding method is exemplified as a method of manufacturing the wide-angle lens in which the ring-shaped second part 12 is arranged on the concave surface side of the first part 11. The manufacture of the wide-angle lens 10 by the injection molding method is described below with reference to FIG. 2 schematically showing a main part of a manufacturing apparatus and a cross-sectional configuration of the wide-angle lens 10 at the time of manufacture. An exemplified injection molding apparatus 20 includes a mold 21, a side surface mold 22, a first part pressing member 23, heaters 24, and a push-up pin 25. The wide-angle lens 10 is formed in a space surrounded by the mold 21, the side surface mold 22, and the first part pressing member 23, and those components can be subjected to temperature management by being sandwiched by the heaters 24.

In an actual manufacturing process, as illustrated in FIG. 2, the first material that becomes the first part 11 is placed on the mold 21, and the side surface mold 22 and the first part 11 are sandwiched by the first part pressing member 23. Then, into a space defined by the first part 11, the mold 21, and the side surface mold 22, the second material provided from a runner is poured while being heated and softened by the heaters 24 that vertically sandwich those components. In this manner, while the second part 12 made of the second material is bonded to the first part 11, the mold shape of the mold 21 can be transferred to the second material.

The mold 21 has a shape with an aspherical surface and a large half aperture angle formed by grinding and polishing, and the second part 12, which is made of the second material to which the shape is transferred, has a shape obtained by reversing the mold 21. To improve releasability of the second part 12 from the mold 21, the surface of the mold 21 can be coated with a film with excellent mold releasability.

After that, the first part 11, the second part 12, the mold 21, and the side surface mold 22 are cooled down to normal temperature, and the mold 21 and the side surface mold 22 are released from the second part 12. Through the above-mentioned process, the wide-angle lens 10 in which the ring-shaped second part 12 is arranged on the concave surface side of the first part 11 can be manufactured. As described above, in injection molding, the mold 21 having the half aperture angle is prepared. Thus, the wide-angle lens 10 can be manufactured by transferring a desired shape to the second part 12.

As the mold used in the exemplified injection molding method, it is preferred to use a mold made of a material having excellent heat resistance. For example, stainless steel, cemented carbide, or the like can be suitably used. Further, the mold 21 is preferred to have a larger linear expansion coefficient, and stainless steel can be suitably used. As the linear expansion coefficient of the mold 21 increases from the heated and softened state to the normal temperature state, shrinkage deformation of the second part 12 toward the mold 21 causing a so-called state of biting into the mold 21 is less liable to occur, thereby reducing a stress that is applied when the second part 12 is cooled.

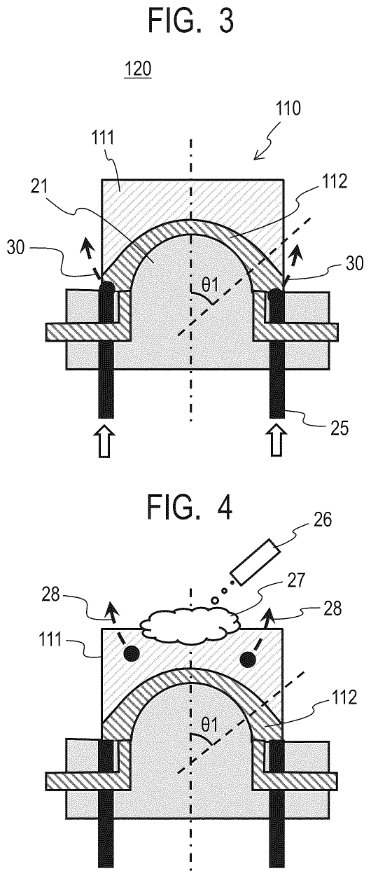

An operation of mold release of a wide-angle lens 110 from the injection molding apparatus in the related art is described with reference to FIG. 3. FIG. 3 schematically shows a state in which, in an injection molding apparatus 120 in a state exemplified in FIG. 2, mold release of the wide-angle lens 110 from the mold 21 is performed through use of the push-up pin 25. As illustrated in FIG. 3, when the push-up pin 25 is used, for example, a second part 112 is released from the mold 21 by raising the second part 112 from an outer peripheral portion of the wide-angle lens 110 in a direction of arrows 30. However, when the half aperture angle θ1 is increased, the adhesion between the second part 112 and the mold 21 is increased due to the biting caused by shrinkage of the second part 112. Thus, a large force is required for performing mold release between those members by the push-up pin 25. Accordingly, when the push-up pin 25 is pushed upward, separation immediately occurs, at a moment at which the force exceeds an adhesive force at an interface between the second part 112 and the mold 21. When the second material for forming the second part 112 is a viscoelastic material, a hard behavior caused by the large force may cause cracking of the wide-angle lens 110.

Accordingly, as exemplified in FIG. 4, a method of releasing the second part 112 from the mold 21 may also be employed without using the force of the push-up pin. In the configuration exemplified in FIG. 4, a coolant jetting nozzle 26 is arranged, and a coolant 27 is jetted from the coolant jetting nozzle 26 to a surface of the first part 111 (surface opposite to the concave surface) to cool the surface. Then, the entire first part 111 is warped in a direction of arrows 28 so that the second part 112 is slowly separated from the mold 21. However, even with this method, for example, when the half aperture angle θ1 exceeds 65 degrees, the second part 112 cannot be cleanly released from the mold 21 only by the warpage deformation of the first part 111, and the wide-angle lens 110 may crack.

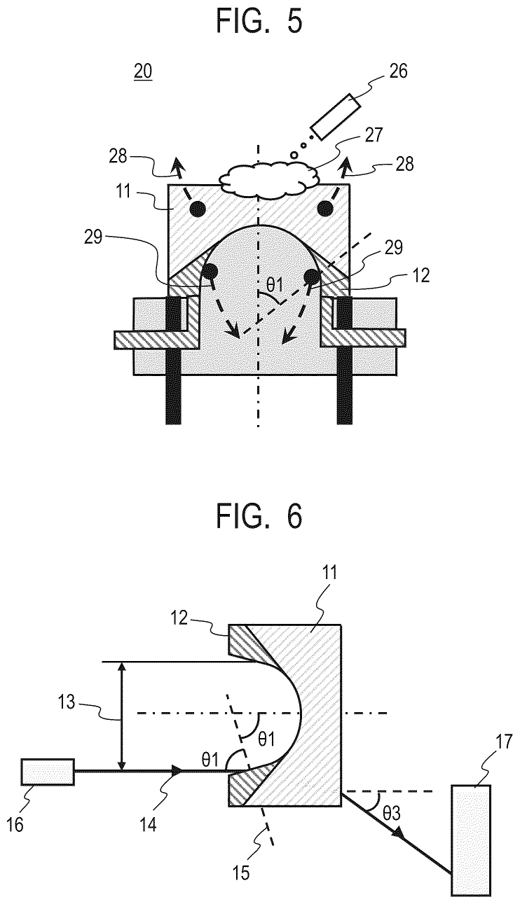

In view of the above, in the present disclosure, with the configuration schematically illustrated in FIG. 5, mold release between the second part 12 and the mold 21 can be facilitated even in the case of the wide-angle lens 10 having a large half aperture angle θ1. Specifically, as exemplified in FIG. 5, the second part 12 is not provided in a center portion of the concave portion of the wide-angle lens 10, and is arranged only at an outer peripheral portion, in a ring shape. Even in the case of such a structure, when the half aperture angle is smaller than 65 degrees, sufficient wide-angle performance cannot be obtained even though the mold release of the wide-angle lens from the mold is facilitated, and, when the half aperture angle is larger than 90 degrees, the mold release of the wide-angle lens from the mold becomes difficult. That is, when the method exemplified in FIG. 5 is used and the half aperture angle is set in the above-mentioned range, a wide-angle lens having a suitable half aperture angle can be stably provided. For example, it has been observed that similar effects can be obtained even when the thickness in the optical axis direction of the second part 12 provided at the center portion of the concave portion is set to 0.01 mm or less. The thickness is preferably 0.005 mm or less. The members are arranged in the injection molding apparatus 20 so that the wide-angle lens 10 has this form after the manufacture, and, after the second part 12 is molded, the surface of the first part 11 is cooled to perform mold release, that is, separation between the second part 12 and the mold 21. Further, the case without use of the push-up pin 25 has been described here, but, for example, when an excessive load to the second part 12 can be managed, mold release can be efficiently performed with use of the push-up pin 25 together.

Further, as described above, in the present disclosure, as the shape of the wide-angle lens 10, there is employed a mode in which the second part 12 is absent at the center portion of the concave portion, or in which the thickness of the second part 12 is very small even when the second part 12 is present at the center portion of the concave portion. Accordingly, when the surface of the first part 11 is cooled, the mold 21 is also cooled by heat transfer, and warpage deformation of the mold 21 in a direction indicated by an arrow 29 can also be used. In this manner, in the case of the wide-angle lens 10 in which the second part 12 is formed as described above, even when the half aperture angle θ1 is large, the second part 12 can be released from the mold 21 without cracking the wide-angle lens 10. However, in the case in which the second part 12 is also provided at the center portion of the concave portion, when the thickness in the optical axis direction falls below 0.0005 mm, high pressure is required for spreading the second part 12 thinly, resulting in an increase in the size of the apparatus, or pressure application time is increased, resulting in a possibility of higher cost. Accordingly, when the second part 12 is provided up to the center portion of the concave portion, it is realistic to set the thickness in the optical axis direction of the center portion of the concave portion to 0.0005 mm or more. In other words, when the thickness in the optical axis direction of the center portion of the concave portion is 0.0005 mm or more and 0.01 mm or less, the second part 12 can be suitably formed in the wide-angle lens 10. However, when the formation condition of the second part 12 is considered, the thickness in the optical axis direction of the center portion of the concave portion is preferably 0.002 mm or more. Further, it is preferred that the second part 12 be shaped so that the thickness in the optical axis direction on the inner side of the ray effective diameter is increased toward the outer circumference, to facilitate release of the mold.

The second part 12 molded by injection molding can also be subjected to heat treatment in order to relax the internal stress. The method of the heat treatment is not particularly limited, but it is preferred that a heating temperature at the time of heat treatment be set to, for example, a heating temperature to the extent that the shape of the second part 12 is not lost, and it is only required to set the time required for sufficiently relaxing the internal stress generated at the time of molding. Further, the injection molding method exemplified as the manufacturing method here is merely an example, and a replica method may be used.

In the wide-angle lens 10 obtained by the above-mentioned method, the half aperture angle θ1 of the ray effective diameter of the second part 12 can satisfy an angle of 65 degrees or more and 90 degrees or less. As a result, an aspherical concave lens having a large half aperture angle can be obtained as being directed in the present disclosure. Further, with the manufacturing method exemplified in FIG. 5, the wide-angle lens 10 of the present disclosure can be stably provided.

Now, a wide-angle action of light in the wide-angle lens 10 according to the present disclosure is described with reference to FIG. 6. FIG. 6 schematically shows a configuration for measuring the wide-angle action when a laser light beam enters the wide-angle lens 10. In more detail, FIG. 6 shows a measurement state of an exit angle θ3 sensed and measured by a photodetector 17 when laser light emitted from a laser light source 16 enters the concave surface side of the wide-angle lens 10. When the laser light enters the wide-angle lens 10 at the half aperture angle θ1, the laser light is refracted by a refracting angle θ2, and exits from the wide-angle lens 10 at the exit angle θ3. In the measurement illustrated in FIG. 6, the wide-angle lens 10 according to one aspect of the present disclosure can obtain a wide-angle action of 26 degrees or more, which is more effective than the related-art wide-angle action.

However, when the half aperture angle θ1 of the second part 12 is larger than 90 degrees, the second part 12 physically bites into the mold 21. Thus, the mold release between those members cannot be performed. Accordingly, the upper limit of the half aperture angle θ1 is 90 degrees or less.

### [Evaluation Method]

Next, using the configuration exemplified in FIG. 6, an evaluation method of evaluating the wide-angle lens according to Examples and Comparative Example to which the present disclosure is applied is described.

As the evaluation method of the wide-angle lens, in this case, a wide-angle lens 10 in which the half aperture angle θ1 on the concave surface side had been changed was prepared. The prepared wide-angle lens 10 had a configuration including a first part 11 having a concave surface and a ring-shaped second part 12 on the concave surface side of the first part 11, and the surface of the first part 11 opposite to the concave surface was a flat surface.

The wide-angle lens 10 produced as described above with dimensions shown in detail below was evaluated by a method as described below. Specifically, laser light that became a parallel light beam 14 was emitted from the laser light source 16 capable of applying wavelength d-rays to a position of @28 mm which was an end portion of a light beam effective range 13 on the concave surface side of the wide-angle lens 10. Then, an angle of light in which the laser light that had passed through the wide-angle lens 10 entered the photodetector 17 was measured. As the exit angle θ3 that can be measured by the photodetector 17 becomes larger, the lens has a larger wide-angle action.

Evaluation criteria for the exit angle θ3 are as follows.

### Evaluation Criteria of Wide-Angle Lens:

◯: Exit angle θ3 is 26 degrees or more.

x: Exit angle θ3 is less than 26 degrees.

The present disclosure is described by means of Examples and Comparative Examples. The present disclosure is not limited to the matters described in Examples below.

### Example 1

In manufacture of a wide-angle lens 101, first, the concave surface side of the first part 11 was processed into a spherical surface, and washing was performed. N-BK7 manufactured by SCHOTT was used as the material for the first part 11 (first material). The first part 11 was washed by putting the first part 11 into an ultrasonic cleaning machine filled with pure water and then putting the first part 11 into a drying machine to evaporate moisture. On the concave surface of the first part, a silane coupling material was applied in order to increase the adhesion to the second part 12 made of resin used as the second material.

Next, grinding and polishing processing was performed on a convex surface of the mold 21 to be used in injection molding, and then hole drilling was performed to allow passage of the second material. The mold 21 was arranged so that the ray effective diameter became 28 mm, and a curvature radius R of the ray effective diameter was set to 31.5 mm. STAVAX™ manufactured by Uddeholm was used as the material to be used for the mold 21, and the surface was coated with a carbon film to increase the mold releasability. The same material was used also for the side surface mold 22, and similar grinding and polishing processing and coating processing were performed to restrict the outer diameter of the first part 11. The conditions applied to Examples and Comparative Example are summarized and described in Table 1, below.

The washed first part 11 and the ground and polished mold 21 and side surface mold 22 were assembled to the state exemplified in FIG. 2, and the temperature of the mold 21 was further raised up to 110 degrees Celsius by the heaters 24. After that, the heated and softened second material was poured and loaded to a space in which the second part 12 was to be formed, and then the heaters 24 were turned off to perform natural cooling down to normal temperature. After that, as exemplified in FIG. 5, the surface of the first part 11 was cooled so that the mold 21 was also cooled, and warpage deformation was caused between the first part 11 and the mold 21 so that the second part 12 was released from the mold 21. Thus, the wide-angle lens 101 was obtained.

The obtained wide-angle lens 101 had a half aperture angle θ1 of 67.019 degrees, an exit angle θ3 of 27.66 degrees, and an evaluation result of ◯.

### Example 2

In Example 2, the curvature radius R of the ray effective diameter of the concave surface of the second part in the wide-angle lens 101 produced in Example 1 was changed to the condition shown in Table 1. Other conditions were similar to those of Example 1, and a wide-angle lens 102 was obtained by the process described in Example 1.

The obtained wide-angle lens 102 had a half aperture angle θ1 of 75.165 degrees, an exit angle θ3 of 30.242 degrees, and an evaluation result of ◯.

### Example 3

In Example 3, the curvature radius R of the ray effective diameter of the concave surface of the second part in the wide-angle lens 101 produced in Example 1 was changed to the condition shown in Table 1. Other conditions were similar to those of Example 1, and a wide-angle lens 103 was obtained by the process described in Example 1.

The obtained wide-angle lens 103 had a half aperture angle θ1 of 85.249 degrees, an exit angle θ3 of 32.122 degrees, and an evaluation result of ◯.

### Comparative Example 1

In Comparative Example 1, the curvature radius R of the ray effective diameter of the concave surface of the second part in the wide-angle lens 101 produced in Example 1 was changed to the condition shown in Table 1. Other conditions were similar to those of Example 1, and a wide-angle lens 104 was obtained by the process described in Example 1.

The obtained wide-angle lens 104 had a half aperture angle θ1 of 61.496 degrees, and an exit angle θ3 of 25.568 degrees. As a result, the effect of the wide-angle lens did not satisfy the exit angle θ3 of 26 degrees in the related art, and the evaluation result was x.

The conditions of the wide-angle lenses 101 to 104 described above in Examples and Comparative Example are shown in Table 1, and the evaluation results are shown in Table 2.

TABLE 1

| | | | Second material | | | |
|---|---|---|---|---|---|---|
| | | | | | Curvature radius | |
| | | | | | R of ray | R of surface |
| | First material | | | Ray | effective | opposite to |
| | Refractive | Center | Refractive | effective | diameter of | concave |
| | index | thickness | index | diameter | concave surface | surface |
| Example 1 | 1.5 | 2 | 1.5 | 28 | 31.5 | ∞ |
| Example 2 | 1.5 | 2 | 1.5 | 28 | 30 | ∞ |
| Example 3 | 1.5 | 2 | 1.5 | 28 | 29.1 | ∞ |
| Comparative | 1.5 | 2 | 1.5 | 28 | 33 | ∞ |
| Example 1 | | | | | | |

TABLE 2

| | | Half aperture | Exit | Wide-angle |
|---|---|---|---|---|
| | Wide-angle | angle θ1 | angle θ3 | lens |
| | lens number | (degree) | (degree) | evaluation |
| Example 1 | 101 | 67.019 | ∘27.66 | ∘ |
| Example 2 | 102 | 75.165 | ∘30.242 | ∘ |
| Example 3 | 103 | 85.249 | ∘32.122 | ∘ |
| Comparative | 104 | 61.496 | x25.568 | x |
| Example 1 | | | | |

From the results of Table 2, it was observed that the wide-angle lenses 101 to 103 described in Examples had the exit angle θ3 falling within the reference value, and were lenses achieving a wider angle than in the case of the related art.

Meanwhile, the wide-angle lens 104 had the exit angle θ3 of 25.568 degrees, and the effect of the wide-angle lens did not satisfy the exit angle θ3 of 26 degrees in the related art.

As described above, in the wide-angle lenses in Examples of the present disclosure, in the ring-shaped second material, the half aperture angle was 65 degrees or more and 90 degrees or less within the ray effective diameter, and thus a lens achieving a wider angle than in the case of the related art was obtained.

### Application Examples

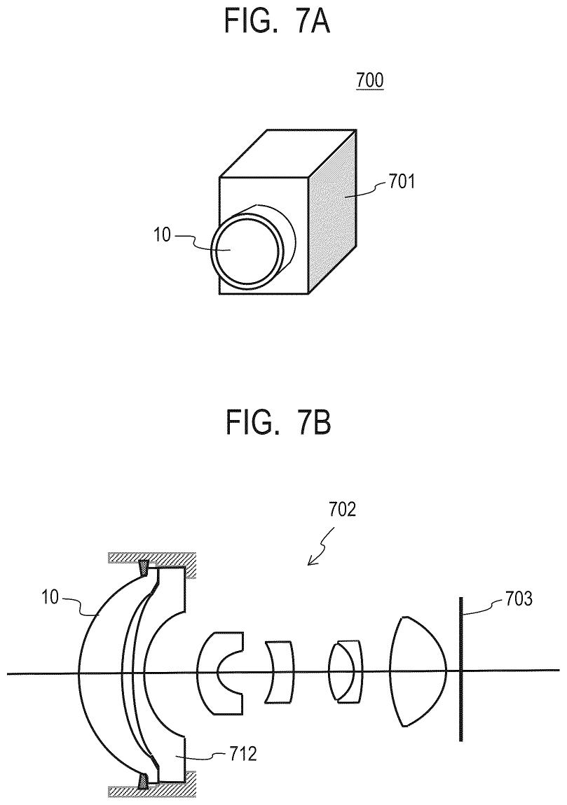

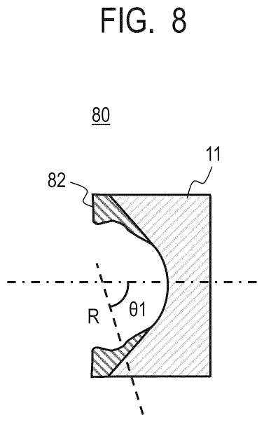

Next, an image pickup apparatus which is an optical device having mounted thereon the wide-angle lens 10 according to the above-mentioned embodiment is described with reference to the drawings. An in-vehicle camera is described as an example of the image pickup apparatus. FIG. 7A and FIG. 7B are views for illustrating a schematic configuration of the in-vehicle camera according to one aspect of the present disclosure to which the wide-angle lens 10 is applied. FIG. 7A is an exterior perspective view, and FIG. 7B schematically shows components relating to an optical system.

An exemplified in-vehicle camera 700 includes an internal optical system (lens unit 702) including a plurality of lenses, an image pickup element 703 for receiving light that has passed through the optical system, and a casing 701 which incorporates those components and the like and in which the above-mentioned wide-angle lens 10 is to be accommodated. It is desired that the in-vehicle camera 700 have a function of capturing an image in a range as wide as possible, and such a demand can be met by using the wide-angle lens 10 according to the embodiment described above.

Further, the wide-angle lens 10 is typically not used alone, but is used as a first lens forming the lens unit 702 that includes the first lens, a second lens 712, and the like. The image pickup element 703 is, for example, a complementary metal oxide semiconductor (CMOS) image sensor or a charge coupled device (CCD) image sensor. The image sensor has a function of converting light that has entered the image sensor via the lens unit 702 into an electrical signal.

As described above, the wide-angle lens 10 which is an example of the lens according to one aspect of the present disclosure includes the first part 11 and the second part 12. The first part 11 has a concave surface and is formed of a first material including glass. The second part 12 is bonded to the concave surface side of the first part 11. The second part 12 is formed into a ring shape, and defines a half aperture angle of a ray effective diameter of the wide-angle lens 10 to an angle of 65 degrees or more and 90 degrees or less. When the wide-angle lens 10 is formed into such a shape, as exemplified in FIG. 5, with the surface of the first part 11 being cooled, the mold 21 can also be cooled so that the mold 21 is deformed. In addition, with the second part 12 defining the half aperture angle of the ray effective diameter to the angle of 65 degrees or more and 90 degrees or less, the mold release of the wide-angle lens 10 from the mold 21 can be more stably performed.

Glass can be as the first material and resin can be as the second material, as examples thereof. Further, the second part 12 has a ring-shaped form, and can be bonded to the concave surface of the first part 11 so as to be positioned in the vicinity of a circumference of a circle forming the ray effective diameter of the lens. As another example, the second part 12 can be bonded to the concave surface of the first part 11 so as to be positioned not to reach the vicinity of the center of the circle forming the ray effective diameter of the lens. The vicinity of the circumference or the vicinity of the center described here means a range including a region on the circumference and around, for example, 20% of the ray effective diameter in a radial direction about the circumference, or a range including a region at the center or around, for example, 80% of the ray effective diameter around the center. However, those values are exemplary, and the values are not strictly defined to those values as long as the surface of the second part 12 that has been in contact with the mold 21 and the concave surface of the first part 11 can form a continuous smooth surface so that the half aperture angle on the circumference can be defined.

A wide-angle lens according to another aspect of the present disclosure can have a mode in which the second part is not ring-shaped but has a part to be bonded also to the center portion of the concave surface of the first part 11. At this time, it is preferred that the center thickness in the optical axis direction of the second part to be bonded to the center of the concave surface of the first part 11 be 0.002 mm or more and 0.005 mm or less. With the center thickness being defined within this range, the second part can define the half aperture angle of the ray effective diameter to an angle of 65 degrees or more and 90 degrees or less, and the mold release of the wide-angle lens 10 from the mold 21 can be more stably performed. The second part having such a form can be formed so that the thickness in the optical axis direction on the inner side of the ray effective diameter can be increased toward the outer circumference.

As exemplified in FIG. 7B, the lens according to an above described aspect of the present disclosure can form a lens unit together with a plurality of lenses including the lens. As exemplified in FIG. 7A and FIG. 7B, the lens according to one aspect of the present disclosure can form an optical device exemplified by an in-vehicle camera together with an optical system including the lens and a casing incorporating the optical system. Moreover, the image pickup apparatus exemplified by the in-vehicle camera can include the image pickup element 703 for receiving light that has passed through the optical system.

### Modification Example

In the above-mentioned embodiment, the second part 12 has a shape such that the thickness in the optical axis direction on the inner side of the ray effective diameter is increased toward the outer circumference. However, the shape of the second part in the lens according to the present disclosure is not limited to the shape exemplified as the embodiment. An example of another shape of the second part is described here with reference to FIG. 8 showing a cross-sectional shape of the lens in a style similar to that of FIG. 1. A lens 80 exemplified in FIG. 8 is formed so that a thickness of a second part 82 is partially reduced in the middle toward the outer circumference. As described above, the shape of the second part can be changed as appropriate depending on the characteristic desired for the lens. In the form illustrated in FIG. 8, excluding the aspherical shape, the thickness in the optical axis direction is increased toward the outer circumference. Further, the form illustrated in FIG. 8 can be rephrased as follows: a thickness distribution obtained by approximating a thickness distribution in the optical axis direction by a quadratic curve is increased toward the outer circumference.

As described above, according to one aspect of the present disclosure, the lens which has the aspherical surface and is capable of capturing an image in a wide range can be stably provided.

The present disclosure refers to the above embodiment and Examples, without being so limited. The present disclosure also encompasses the disclosure modified within a scope that does not deviate from the present disclosure, and equivalents thereof, as understood by one of skill in the art. Further, the above-mentioned embodiment and Examples may be combined with each other as appropriate within the scope not deviated from the gist of the present disclosure.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims priority to and the benefit of Japanese Patent Application No. 2024-125002, filed Jul. 31, 2024, which is hereby incorporated by reference herein in its entirety.

What is claimed is:

1. A lens comprising:
a first part, which is made of a first material, and has a concave surface; and
a second part, which is made of a second material, and is configured to be bonded to the concave surface side of the first part,
wherein the second part is formed into a ring shape, and the second part defines a half aperture angle of a ray effective diameter to an angle of 65 degrees or more and 90 degrees or less.

2. The lens according to claim 1, wherein the first material includes glass, and the second material includes resin.

3. The lens according to claim 1, wherein the second part is formed to be positioned in a vicinity of a circumference of a circle of the ray effective diameter.

4. The lens according to claim 1, wherein the second part is formed to be positioned to prevent reaching a center of a circle of the ray effective diameter.

5. A lens unit comprising a plurality of lenses including the lens of claim 1.

6. An optical device comprising:
an optical system including the lens of claim 1; and
a casing configured to incorporate the optical system.

7. An image pickup apparatus comprising:
an optical system including the lens of claim 1;
an image pickup element configured to receive light that has passed through the optical system; and
a casing configured to incorporate the optical system and the image pickup element.

8. A lens comprising:
a first part, which is made of a first material, and has a concave surface; and
a second part, which is made of a second material, and is configured to be bonded to the concave surface side of the first part,
wherein the second material has a center thickness of 0.0005 mm or more and 0.01 mm or less, and the second part defines a half aperture angle of a ray effective diameter to an angle of 65 degrees or more and 90 degrees or less.

9. The lens according to claim 8, wherein the first material includes glass, and the second material includes resin.

10. The lens according to claim 8, wherein, in the second part, a thickness in an optical axis direction on an inner side of the ray effective diameter is increased toward an outer circumference.

11. The lens according to claim 8, wherein the second material has the center thickness of 0.002 mm or more and 0.005 mm or less.

12. A method of manufacturing a lens, the method comprising:
forming, on a side of a concave surface of a first part which is made of a first material, a second part between a mold and the concave surface using a second material to have a center thickness of 0.01 mm or less;
cooling the first part from a side opposite to the side of the first part on which the concave surface is formed;
cooling the mold via a center portion of the second part; and
separating the mold from the second part,
wherein the separation uses deformation of the first part due to the cooling of the first part and deformation of the mold due to the cooling of the mold.
